(19) United States
(12) Patent Application Publication
(10) Pub. No.: US 2018/0018879 A1
(43) Pub. Date: Jan. 18, 2018

(54) Garage Laser Parking Guide

(71) Applicant: John Frederick Brownell, San Jose, CA (US)

(72) Inventor: John Frederick Brownell, San Jose, CA (US)

(21) Appl. No.: 15/210,436

(22) Filed: Jul. 14, 2016

(51) Int. Cl. G08G 1/16

(52) U.S. Cl. CPC G08G 1/168

(57) ABSTRACT

A laser based parking guide that indicates when vehicles have just cleared the garage vehicle entry door allowing maximum clearance forward of the vehicle. This guide can be used in multiple car garages and needs no realignment for different vehicles.

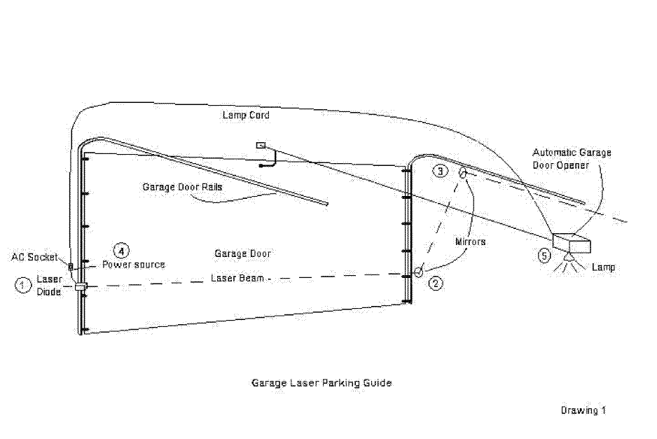

### BACKGROUND OF INVENTION

Most garages are used for both motor vehicles and storage space. Walking space can be compromised when a vehicle is parked in the garage too far forward. This present invention ‘Garage Laser Parking Guide’ allows multiple vehicles to be positioned in the garage leaving maximum clearance forward of each vehicle.

### SUMMARY

Embodiments of this invention improve vehicle parking in a limited space environment by use of an optical laser transmission device described herein. This invention also redirects the laser beam away from harmful intrusion into user's eyes by means of adjustable mirrors.

### DESCRIPTION OF DRAWING

Drawing 1 shows Garage Door and automatic opener components along with mounted Garage Laser Parking Guide and references to Claims described below.

### DETAILED DESCRIPTION OF THE INVENTION

This invention makes use of a focused laser diode and 1 or more mirrors. These components mount to the rail guides of the garage vehicle entry door with magnets and fully articulating joints, which allow the components to be aligned. The laser is mounted at bumper height on one side rail of the garage vehicle entry door aimed to a mirror mounted on the opposite side rail at the same height. The first mirror is aligned such as to redirect the laser beam either up to another rail mounted mirror or forward. The forward directed mirror is aligned to redirect the laser beam to a spot on the front wall that can be seen by the driver. When the driver can see the laser dot on the forward wall the automobile is fully in the garage and the can be stopped. This allows maximum clearance between front of the vehicle and the forward wall. Power for the laser diode is supplied via the automatic garage door lamp circuit. Two wires are attached in parallel to the lamp circuit and routed near the laser diode and terminated into an ac receptacle. The laser diode circuit takes power thru a standard USB adapter.

1. Laser diode magnetically mounted at bumper level on one side of garage vehicle entry door aimed to a point level on opposite side of the garage vehicle entry door.

2. Laser beam point of claim 1 is redirected via a magnetically mounted adjustable mirror vertically away from any path that could target user's eye.

3. Laser beam point of claim 2 is then redirected forward using another magnetically mounted adjustable mirror above eye level and onto a forward wall as a red spot.

4. Laser diode of claim 1 is powered thru a voltage regulator i.e. transformer or USB charge adapter.

5. Voltage supply of claim 4 is delivered from the lamp circuit built into the automatic garage door opener.

6. Claims 1-6 allow a vehicle to be driven just forward of the garage vehicle entry door allowing it to close fully leaving maximum space forward of the vehicle and minimum distance between rear bumper and door.

7. Claim 1-6 allows multiple vehicles to use the same system in a multiple car garage.
